(19) United States
(12) Patent Application Publication
(10) Pub. No.: US 2002/0055344 A1
(43) Pub. Date: May 9, 2002

(54) Radio-frequency receiver

(76) Inventor: Mamoru Shimoda, Kitakatsuragi-Gun (JP)

Correspondence Address: BIRCH STEWART KOLASCH & BIRCH, PO BOX 747, FALLS CHURCH, VA, 22040-0747, US

(21) Appl. No.: 09/941,558

(22) Filed: Aug. 30, 2001

(30) Foreign Application Priority Data
Aug. 30, 2000 (JP) 2000-260456

(51) Int. Cl. H04B 1/06

(52) U.S. Cl. 455/260; 455/264

(57) ABSTRACT

A radio-frequency receiver mixes a received radio-frequency signal with a local signal in a mixer to convert the radio-frequency signal into an intermediate-frequency signal or baseband signal. In this radio-frequency receiver, a frequency multiplier circuit multiplies the frequency of the output signal of a VCO and feeds the resulting signal as the local signal to the mixer. The output level of the frequency multiplier circuit is switched by a level switcher circuit, which is controlled by a tuning controller according to the received frequency. The controller also controls a PLL circuit for tuning.

### BACKGROUND OF THE INVENTION

1. Field of the Invention

The present invention relates to a radio-frequency receiver, and particularly to a digital satellite broadcast receiver.

2. Description of the Prior Art

FIG. 1 shows a circuit block diagram around the local signal generator in a conventional radio-frequency receiver. In this figure, reference numeral 2 represents a local signal generator, and reference numeral 3 represents a mixer.

The local signal output from the local signal generator 2 is fed to the mixer 3. The local signal fed to the mixer 3 is mixed with an RF (radio-frequency) signal fed in via an input path L0, so that the RF signal is converted into an intermediate-frequency signal or baseband signal.

This conventional technique, however, has the following disadvantages. Specifically, in a conventional configuration as shown in FIG. 1, the local signal generator 2 itself has a specific frequency response, which causes the conversion gain, noise figure, and harmonic interference characteristic of the mixer 3 to vary according to the frequency. Here, the harmonic interference characteristic is expressed as the ratio D/U of a desired signal D to an interfering signal U when a received signal, i.e. the desired signal, has the same frequency as a harmonic component of the local signal and this harmonic component is also received as the interfering signal. That is, the higher the ratio D/U, the better the harmonic interference characteristic.

Moreover, in particular in the reception of satellite broadcast, it is necessary, in a lower received frequency band, to secure a satisfactory harmonic interference characteristic by lowering the input level to the mixer and, in a higher received frequency band, to obtain satisfactory performance in terms of the conversion gain, noise figure, and other parameters by keeping the input level to the mixer above a certain level. This, however, cannot be realized in a conventional configuration as shown in FIG. 1

### SUMMARY OF THE INVENTION

An object of the present invention is to provide a radio-frequency receiver that ensures a stable frequency response in the local signal output level and that permits switching of the output level according to the frequency.

To achieve the above object, according to the present invention, a radio-frequency receiver includes a local signal generator, and is provided with a mixer for mixing a received radio-frequency signal with a local signal to convert the radio-frequency signal into an intermediate-frequency signal or baseband signal, a level switcher for switching the output signal level of the local signal generator, and a controller for controlling the level switcher according to the frequency of the received signal. In this configuration, by varying the output level of the local signal generator according to the received frequency by the use of the level switcher, it is possible to keep the output level constant over the whole receivable frequency range.

Here, the radio-frequency receiver may be further provided with a VCO (voltage-controlled oscillator) and a frequency multiplier circuit for multiplying the frequency of the output signal of the VCO. In this configuration, by varying the output level of the frequency multiplier circuit according to the received frequency by the use of the level switcher, it is possible to keep the output level constant over the whole receivable frequency range.

Alternatively, the radio-frequency receiver may be further provided with a plurality of VCOs and a VCO switcher for switching among the VCOs so that one of them is selected and connected to the frequency multiplier circuit at a time. In this configuration, it is possible to switch VCOs according to the received frequency, and thus to vary the input level to the frequency multiplier circuit according to the received frequency. By combining this switching with the switching of the output level of the frequency multiplier circuit, it is possible to keep the output level constant over the whole receivable frequency range, or to switch the output level among different levels for a plurality of bands demarcated within the receivable frequency range.

Moreover, the local signal generator may include a PLL (phase-locked loop) circuit for controlling the oscillation frequency of the VCO so that the controller controls the VCO through the PLL circuit by using a control signal and also controls the level switcher by using another control signal corresponding to the control signal. In this configuration, the use of the control signal that corresponds to the control signal for the PLL circuit makes it possible to switch the output level of the frequency multiplier circuit in finer steps according to the frequency, and to combine this switching freely with the switching performed by the VCO switcher.

The level switcher may include a regulator. By combining the regulator with a simple circuit such as a resistor or switch, it is possible to achieve the desired level switching.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing a relevant portion of a conventional radio-frequency receiver;

FIG. 2 is a block diagram showing a relevant portion of a radio-frequency receiver embodying the invention;

FIG. 3 is a characteristic diagram showing the frequency response of the radio-frequency receiver;

FIG. 4 is a circuit diagram of the level switching circuit of the radio-frequency receiver;

FIG. 5 is a circuit diagram of the level changing portion of the frequency multiplier circuit of the radio-frequency receiver;

FIG. 6 is a circuit diagram of the frequency multiplier portion of the frequency multiplier circuit of the radio-frequency receiver;

FIG. 7 is a block diagram showing the relationship between the switching of the output level of the frequency multiplier circuit and the control of the VCO in the radio-frequency receiver;

FIG. 8 is a circuit diagram of another example of the level switcher circuit of the radio-frequency receiver;

FIG. 9 is a block diagram showing the relationship between the switching of the output level of the frequency multiplier circuit and the control of the selection/switching among the VCOs in the radio-frequency receiver;

FIG. 10 is a block diagram of a digital satellite broadcast receiver to which the present invention is applied;

FIG. 11 is a diagram showing an example of the frequency response of the digital satellite broadcast receiver; and

FIG. 12 is a diagram showing another example of the frequency response of the digital satellite broadcast receiver.

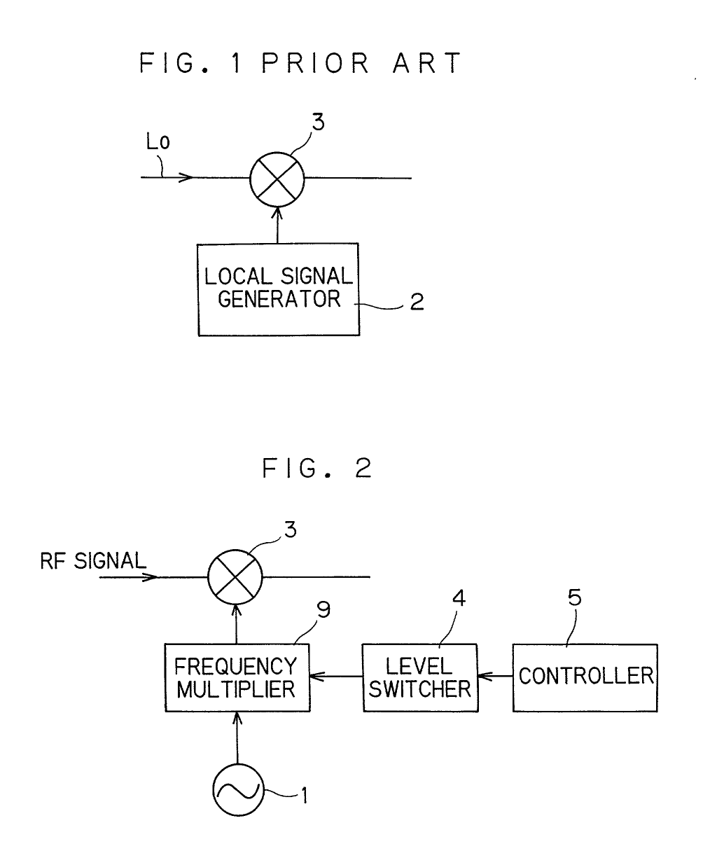

### DESCRIPTION OF THE PREFERRED EMBODIMENTS

Hereinafter, embodiments of the present invention will be described with reference to the drawings. FIG. 2 is a block diagram showing the configuration of the radio-frequency receiver of a first embodiment of the invention. As FIG. 2 shows, the radio-frequency receiver of this embodiment is provided with a VCO (voltage-controlled oscillator) 1, a frequency multiplier circuit 9, a level switcher circuit 4, and a controller 5 for controlling the level switcher circuit 4. The signal output from the VCO 1 is fed to the frequency multiplier circuit 9, where the signal is converted to a signal having twice its original frequency. This converted signal is fed as a local signal to the mixer 3, which mixes an RF signal with the local signal and thereby converts the RF signal into an intermediate-frequency signal or baseband signal. Here, the output level of the frequency multiplier circuit 9 is kept constant, for example, by a method disclosed in Japanese Patent Application Laid-Open No. H11-366028.

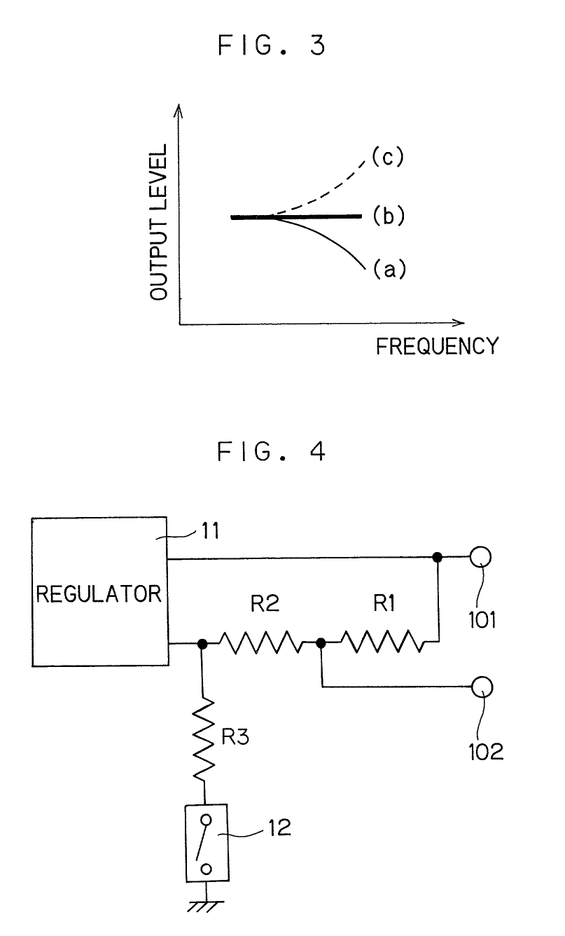

However, usually the frequency multiplier circuit 9 itself has a specific frequency response, and therefore, as indicated by the curve (a) in FIG. 3, even if the output level is kept constant at a certain frequency, it decreases as the frequency increases. To overcome this, the output level of the frequency multiplier circuit 9 is switched by the use of the level switcher circuit 4 and the controller 5 in such a way as to exhibit a frequency response as indicated by the curve (c) in FIG. 3. This makes it possible to keep the actual output level constant so that it exhibits a frequency response as indicated by the straight line (b) in FIG. 3. In FIG. 3, along the horizontal axis is taken the frequency, and along the vertical axis is taken the output level.

FIG. 4 shows an example of the configuration of the level switcher circuit 4. This circuit 4 is realized by the use of a regulator (stabilized power supply circuit) 11, a switch 12, and resistors R1, R2, and R3. When the switch 12 is off (open), an output voltage that is determined by the reference voltage of the regulator 11 and the resistances of the resistors R1 and R2 is output between terminals 101 and 102. When the switch 12 is on (closed), the current that flows through the resistor R3 makes the voltage drop across the resistor R1 greater, and thus the voltage difference between the terminals 101 and 102 becomes greater. This is used as a control voltage for controlling the level changing portion of the frequency multiplier circuit 9 shown in FIG. 2 to achieve the switching of the level of the local signal.

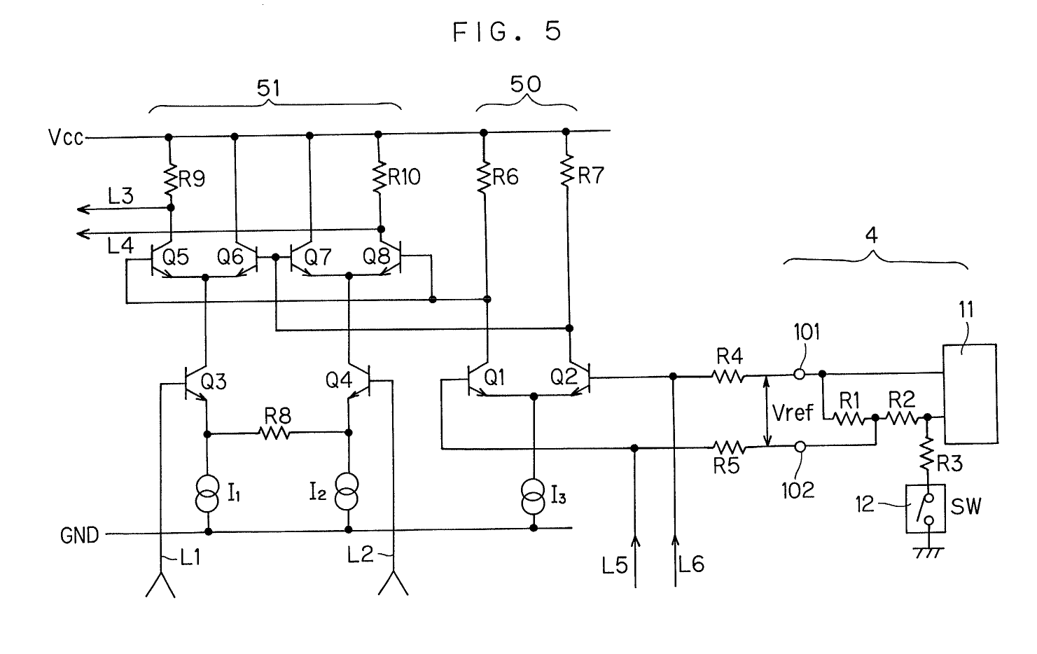

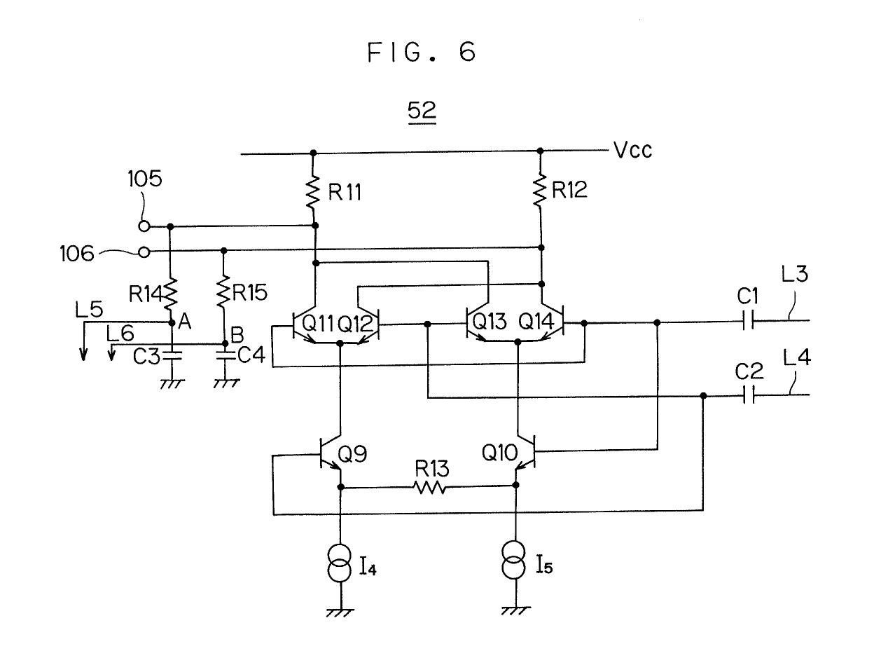

Now, how this is achieved will be described with reference to FIGS. 5 and 6. FIG. 5 shows, in addition to the configuration of the level switcher circuit 4 shown in FIG. 4, a practical example of the configuration of the level changing portion of the frequency multiplier circuit 9. FIG. 6 shows the frequency multiplier portion of the frequency multiplier circuit 9. In FIG. 5, via lines L1 and L2, the output of the VCO 1 is fed in in the form of a differential signal. This differential signal is amplified by a double-balanced differential amplifier 51 composed of transistors Q3 to Q8, resistors R8, R9, and R10, and constant-current sources I₁ and I₂, and is then output to lines L3 and L4. Transistors Q1 and Q2, resistors R6 and R7, and a constant-current source I₃ together constitute a direct-current amplifier 50, and to the bases of the differential pair transistors Q1 and Q2 is fed a direct-current voltage Vref from the aforementioned level switcher circuit 4 via the terminals 101 and 102 and through resistors R4 and R5.

When the switch 12 is off, the current that flows through the resistors R1 and R2 is small, and therefore the voltage drop Vref across the resistor R1 is small. In this state, the output voltage of the direct-current amplifier 50 is accordingly low, and therefore the upper-stage differential pair transistors Q5 to Q8 of the double-balanced differential amplifier 51 are biased only lightly, with the result that the oscillation signal from the VCO fed in via the lines L1 and L2 is amplified only slightly.

By contrast, when the switch 12 is turned on, the voltage drop Vref across the resistor R1 becomes greater, and thus the output voltage of the direct-current amplifier 50 becomes higher. Accordingly, the transistors Q5 to Q8 of the double-balanced differential amplifier 51 are biased more heavily, offering a higher gain. As a result, the level of the oscillation signal from the VCO fed in via the lines L1 and L2 becomes higher. The output of this level changing portion, constituted by the direct-current amplifier 50 and the double-balanced differential amplifier 51, is fed via the lines L3 and L4 to the frequency multiplier portion 52 shown in FIG. 6. Here, the DC (direct-current) component contained in this signal is cut by capacitors C1 and C2 so as not to be transferred.

In FIG. 6, the frequency multiplier portion 52 is composed of a double-balanced differential amplifier consisting of transistors Q9 to Q14, resistors R11, R12, and R13, and constant-current sources I₄ and I₅. The input signal is fed in via the lines L3 and L4, and is then fed to both the lower-stage differential pair transistors (Q9 and Q10) and the upper-stage differential pair transistors (Q11 to 14). The upper-stage differential pair transistors multiply the input signal by the input signal itself to produce a frequency component having twice the frequency of the input signal. The local signal thus obtained is fed via output terminals 105 and 106 to the mixer 3. The level of this local signal output via the terminals 105 and 106 is determined by the circuit portion shown in FIG. 5 described earlier; in other words, the level of the local signal appearing at the terminals 105 and 106 differs according to whether the switch 12 is on or off.

In FIG. 6, a resistor R14 and a capacitor C3 together constitute a low-pass filter, and a resistor R15 and a capacitor C4 together constitute a low-pass filter. These permit the DC component appearing at the nodes A and B to be extracted and fed via lines L5 and L6 back to the bases of the transistors Q1 and Q2 shown in FIG. 5. The DC voltage appearing at the nodes A and B is commensurate with the level of the local signal appearing at the output terminals 105 and 106, and therefore, by feeding back this DC voltage, it is possible to suppress small fluctuations in the level of the local signal.

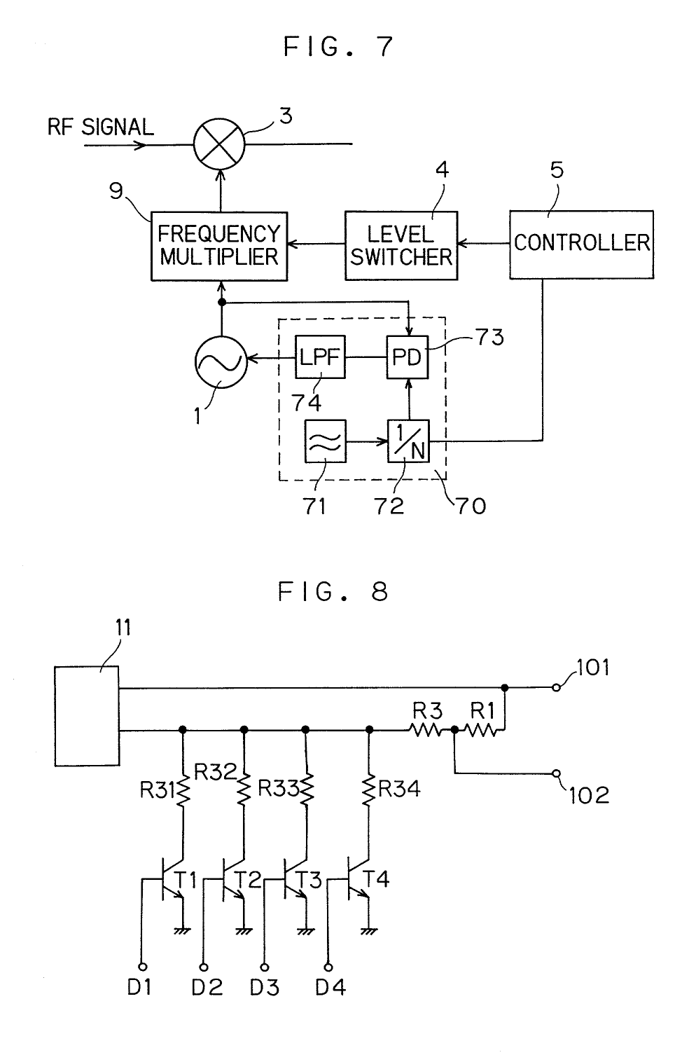

Preferably, whether the switch 12 is turned on or off is determined according to what channel to receive (i.e. the received frequency), as realized in an embodiment shown in FIG. 7. In such a case, the switch 12 is turned off for channels with low received frequencies and on for channels with high received frequencies. However, by two-step switching, it is not possible to obtain a frequency response as indicated by the curve (c) in FIG. 3 in a given frequency range. This can be improved by switching the voltage at the output terminal 102 of the level switcher circuit 4 in multiple steps, as realized in another embodiment shown in FIG. 8.

As FIG. 7 shows, channel switching is typically achieved by controlling a PLL (phase-locked loop) circuit 70 by the use of the controller 5, and therefore level switching can be controlled in a fashion interlocked with channel switching. In this case, the controller provided in the tuning device can be shared as the controller 5. As is well known, the PLL circuit 70 is composed of a reference oscillator 71, a frequency divider 72, a phase comparator 73, and a low-pass filter 74. The phase comparator 73 compares the output of the VCO 1 with a frequency obtained as a result of the frequency divider 72 dividing the reference oscillation frequency generated by the reference oscillator 71, and the VCO 1 is controlled according to the results of the comparison.

For channel selection, the controller 5 of the tuning device outputs a division factor N that corresponds to a given channel. According to this division factor N, the output frequency of the frequency divider 72 is set, and the VCO 1 is controlled accordingly. Whether to turn the switch 12 on or off is stored beforehand in the register of the controller 5 so that, in response to the selection of a channel, the corresponding data, specifying either “on” or “off”, is fed to the level switcher circuit 4.

In FIG. 8, in place of the resistor R3 for level switching shown in FIG. 4, four resistors R31 to R34 are connected in parallel, and, between those resistors and ground, switching transistors T1 to T4, respectively, are connected. To the bases of the transistors T1 to T4, the controller 5 feeds four-bit binary data on a one-bit-to-one-transistor basis. In this way, according to the combination of the on/off states of the transistors T1 to T4, it is possible to vary the total current that flows through those transistors and thereby achieve switching in multiple steps. Here, preferably, the resistances of the resistors R31 to R34 are assigned different weights. For example, by assigning weights in such a way that the currents flowing through the resistors R31, R32, R33, and R34 are i, 2 i, 4 i, and 8 i, respectively, it is possible to realize switching in 16 steps.

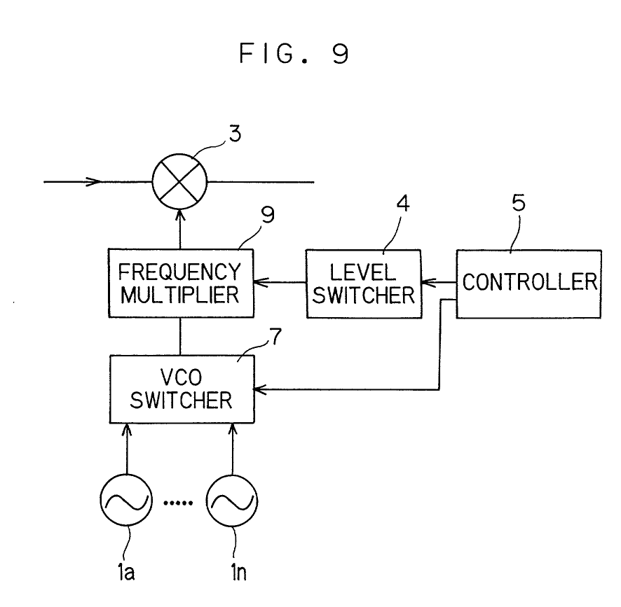

In still another embodiment shown in FIG. 9, a plurality of VCOs oscillating in different frequency ranges are provided beforehand, and in addition a VCO switcher circuit 7 is provided that switches among the outputs of the different VCOs in a fashion interlocked with tuning. In wide-band receivers such as those for receiving satellite or CATV broadcast, it is usually impossible to cover the whole receivable frequency range with a single VCO, and therefore it is customary to use two ore more VCOs and switch among them according to the received frequency. An attempt to cover wide-band signals with a configuration using a single VCO as shown in FIG. 2 is doomed to make the frequency response indicated by the curve (a) in FIG. 3 so uneven that, even if the output level of the frequency multiplier circuit 9 is switched according to the frequency (channel), it is difficult to obtain an even frequency response. This is because the output level of the VCO 1 itself varies according to the frequency, and this variation adds to the variation due to the frequency response of the frequency multiplier circuit, producing very large variation.

This can be overcome by switching among a plurality of VCOs 1a to 1n as shown in FIG. 9. In this way, it is possible to obtain an even frequency response in the output level of the frequency multiplier circuit 9 even with wide-band signals.

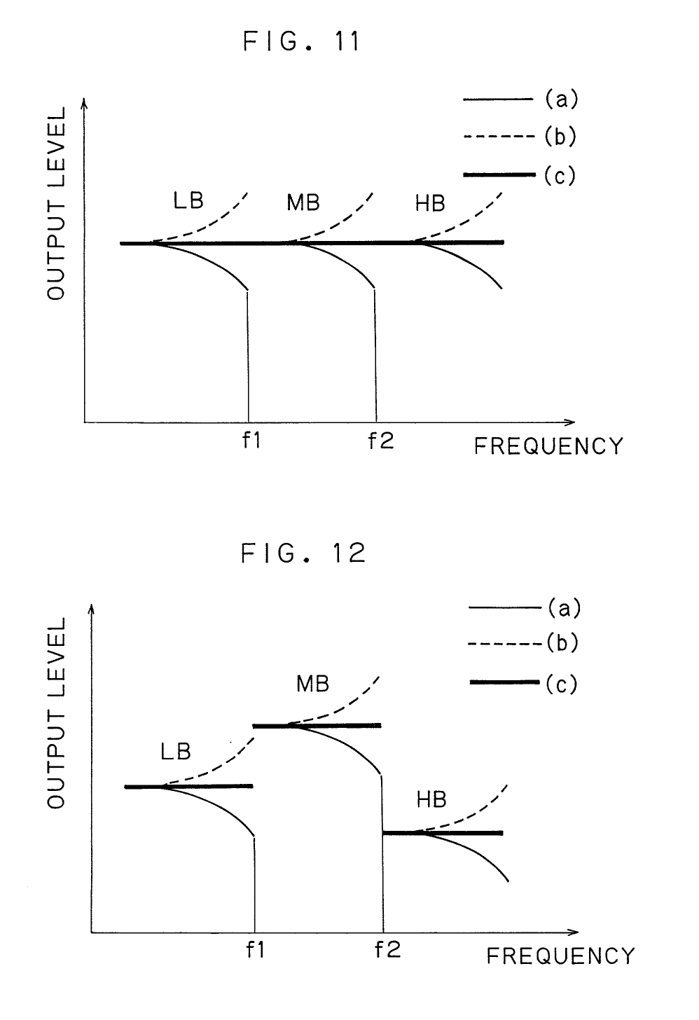

FIG. 11 shows an example of the frequency response obtained with particularly wide-band input. In FIG. 11, VCOs are switched at frequencies f1 and f2. In this case, three VCOs need to be provided beforehand.

In a case where such wide-band input is handled with different center levels in a low band LB, a middle band MB, and a high band HB as shown in FIG. 12, the level may be switched according to the band.

That is, not only is the level switched according to the channel as described above within each band, but it is switched also according to the band. This can be realized by providing the level switching circuit shown in FIG. 4 or 8 additionally with a function of switching a particular voltage among different levels from one band to another. For example, it is possible to switch the voltage output from the regulator 11 to the output terminal 101 according to the band, and switch the voltage delivered to the output terminal 102 according to the channel as in the embodiment described above.

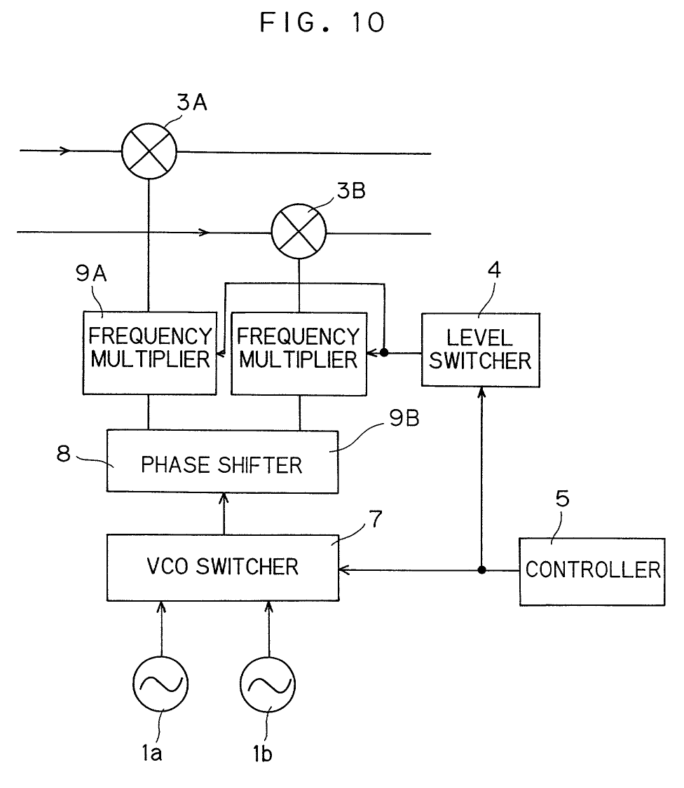

FIG. 10 is a block diagram showing an example of the configuration of a digital satellite broadcast receiver embodying the invention. In FIG. 10, according to a control signal from a PLL, a VCO switcher circuit 7 chooses between the output signals of VCOs 1a and 1b, and the signal thus chosen is fed to a phase shift circuit 8, which converts the signal fed thereto into two signals having a phase difference of 45° from each other. These converted signals are fed to frequency multiplier circuits 9A and 9B, which convert those signals into signals having twice their original frequency and having a phase difference of 90° from each other. One of the resulting signals is fed as an I local signal to a mixer 3A, and the other is fed as a Q local signal to a mixer 3B.

The mixers 3A and 3B respectively mix the I and Q local signals fed thereto with an RF signal, and thereby convert the RF signal into I and Q intermediate-frequency signals or I and Q baseband signals. The two VCOs 1a and 1b are switched at about the center of the receivable frequency range, and, in a fashion interlocked with this switching, the output level of the frequency multiplier circuits 9A and 9B is switched. Specifically, in the lower received frequency band, the output level of the frequency multiplier circuits 9A and 9B is reduced, and, in the higher received frequency band, the output level of the frequency multiplier circuits 9A and 9B is increased. That is, the level is not kept constant over the whole receivable frequency range, but is varied according to the band. In this way, it is possible, in the lower received frequency band, to decrease the input level to the mixers 3A and 3B and thereby secure a satisfactory harmonic interference characteristic and, in the higher received frequency band, to increase the input level to the mixers 3A and 3B and thereby obtain satisfactory performance in terms of the conversion gain, noise figure, and other parameters.

As described above, according to the present invention, a radio-frequency receiver is provided with a local signal generator, a level switcher, and a controller for controlling the level switcher. By the use of the level switcher and the controller, it is possible to keep the output level of the local signal generator constant at a desired level so as to exhibit an even frequency response. This helps make even the frequency response of the input level of the local signal to the mixer circuit in the next stage, and thus makes it possible to optimize the conversion gain, noise figure, and other parameters of the mixer.

Moreover, according to the present invention, the radio-frequency receiver may be further provided with a VCO, a frequency multiplier circuit for multiplying the output frequency of the VCO, a level switcher for switching the output level of the frequency multiplier circuit, and a controller for controlling the level switcher. The level switcher and the controller operate so as to keep the output level of the local signal generator constant at a desired level so as to exhibit an even frequency response. This helps make even the frequency response of the input level of the local signal to the mixer circuit in the next stage, and thus makes it possible to optimize the conversion gain, noise figure, and other parameters of the mixer.

Alternatively, according to the present invention, the radio-frequency receiver may be further provided with a plurality of VCOs, a VCO switcher, a frequency multiplier circuit, a level switcher, and a controller for controlling the level switcher. This makes it possible to switch the output level of the VCO among different levels for a plurality of frequency bands and thereby reduce variation in the frequency response of the input level to the frequency multiplier circuit. This switching can be used in combination with the switching of the output level of the frequency multiplier circuit to obtain an even frequency response in the output level of the frequency multiplier circuit. This method can be used, even when the receiver is designed for wide-band reception, to make even the frequency response of the input level of the local signal to the mixer.

Moreover, by switching among the outputs of a plurality of VCOs and switching the output level of the frequency multiplier circuit according to the received frequency band, it is possible to switch the output level of the frequency multiplier circuit among different levels for a plurality of frequency bands demarcated within the receivable frequency range.

Moreover, according to the present invention, the controller may perform necessary control by using a control signal that corresponds to the control signal for a PLL circuit. This makes it possible to freely combine the switching among a plurality of VCOs and the switching of the output level of the frequency multiplier circuit according to the received frequency. Thus, it is possible to keep the output level of the frequency multiplier circuit constant with more accuracy, and to switch the output level according to the received frequency.

By incorporating a radio-frequency receiver embodying the present invention in a digital satellite broadcast receiver, it is possible to obtain a satisfactory harmonic interference characteristic and simultaneously secure a satisfactory local level in a higher received frequency band.

What is claimed is:

1. A radio-frequency receiver comprising:
a mixer for mixing a received radio-frequency signal with a local signal to convert the radio-frequency signal into an intermediate-frequency signal or baseband signal;
a local signal generator;
a level switcher for switching an output signal level of the local signal generator; and
a controller for controlling the level switcher according to a frequency of the received signal.

2. A radio-frequency receiver as claimed in claim 1,
wherein the local signal generator comprises a voltage-controlled oscillator and a frequency multiplier circuit for multiplying a frequency of an output signal of the voltage-controlled oscillator.

3. A radio-frequency receiver as claimed in claim 2,
wherein the local signal generator includes a phase-locked loop circuit for controlling an oscillation frequency of the voltage-controlled oscillator, and the controller controls the voltage-controlled oscillator through the phase-locked loop circuit by using a control signal, and also controls the level switcher by using another control signal corresponding to the control signal.

4. A radio-frequency receiver as claimed in claim 1,
wherein the level switcher comprises a regulator and a switch for varying an output voltage of the regulator, and varies a gain of the frequency multiplier circuit by using the output voltage of the regulator.

5. A radio-frequency receiver as claimed in claim 1,
wherein the radio-frequency receiver is for receiving digital satellite broadcast.

6. A radio-frequency receiver as claimed in claim 1,
wherein the local signal generator comprises a plurality of VCOs and a VCO switcher for switching among the VCOs so that one of the VCOs is selected and connected to the frequency multiplier circuit at a time.

7. A radio-frequency receiver as claimed in claim 6,
wherein the controller controls both the level switcher and the VCO switcher according to the frequency of the received signal
